(19) United States
(12) Patent Application Publication
(10) Pub. No.: US 2024/0045805 A1
(43) Pub. Date: Feb. 8, 2024

(54) CORE-AWARE CACHING SYSTEMS AND METHODS FOR MULTICORE PROCESSORS

(71) Applicant: Alibaba Group Holding Limited, Georgetown, Grand Cayman (KY)

(72) Inventors: Lide DUAN, Sunnyvale, CA (US); Guocai ZHU, Sunnyvale, CA (US); Yen-kuang Chen, Palo Alto, CA (US); Hongzhong ZHENG, Los Gatos, CA (US)

(21) Appl. No.: 17/637,783

(22) PCT Filed: Jan. 20, 2021
(86) PCT No.: PCT/CN2021/072940

§ 371 Date: Jul. 28, 2022

(51) Int. Cl. G06F 12/084; G06F 12/0811; G06F 12/0882

(52) U.S. Cl. CPC G06F 12/084; G06F 12/0811; G06F 12/0882

(57) ABSTRACT

Core-aware caching systems and methods for non-inclusive non-exclusive shared caching based on core sharing behaviors of the data and/or instructions. In one implementation, the caching between a shared cache level and a core specific cache level can be based on physical page number (PPN) and core identifier sets for previous accesses to the respective physical page numbers. In another implementation, the caching between a shared cache level and a core specific cache level can be based on physical page number and core valid bit vector sets for previous accesses to the respective physical page numbers by each of the plurality of cores.

### CROSS-REFERENCE TO RELATED APPLICATIONS

This application claims priority to PCT Application No. PCT/CN2021/072940 filed Jan. 20, 2021, which is incorporated herein in its entirety.

### BACKGROUND OF THE INVENTION

Some common aspects of computing devices are multicore processors and memory caching. Multicore a plurality of computing cores configured to run multiple applications, multiple routines within an application, multiple instance of a given routine, and or the like to enhance computing performance. Memory caching is utilized to temporarily store data and/or instructions that are commonly used by the cores of a computing device to further enhance computing performance. The cache memory can be organized into a plurality of levels, can be configured to cache data, instructions or both, and can be specific (private, allocated, exclusive, etc.) to respective compute cores or shared between the plurality compute cores. Cache memory can be internal to the multicore processor, external to the multicore processor, or some cache layers can be integral and other cache layers can be external to the multicore processor.

Referring to FIG. 1, an exemplary processor according to the conventional art is shown. The processor 100 can include, but is not limited to, a plurality of cores 105-115, a plurality of levels of cache 120-150, and one or more interconnect interfaces 155-160. The plurality of levels of cache 120-150 can include one or more levels of cache 120-145 that are specific to respective ones of the plurality of cores 105-115, and one or more levels of cache 150 that are shared between the plurality of cores 105-115. For example, the processor 100 can include a plurality of level one (LI) caches 120-130 and a plurality of level two (L2) caches 134-145. Each level one (LI) cache 120-130 and each level two (L2) cache 135-145 can be configured to cache data and/or instructions for a respective one of the plurality of cores 105-115. The plurality of levels of cache 120-150 can also include one or more levels of cache 150 that are shared by the plurality of cores 105-115. For example, the processor 100 can include one or more level three (L3) caches 150 that configured to cache data and/or instructions for the plurality of cores 105-115.

The one or more interconnect interfaces can include one or more memory controllers 155 can be configured to process memory accesses requests. The one or more memory controllers 155 can be coupled between one or more external memories 165-170 and one or more of the levels of cache 120-150. For example, the processor 100 can include a memory controller 155 coupled between one or more dynamic random-access memory (DRAM) 165-170 and the plurality of levels of cache 120-150. The memory controller 155 can be configured to read data from the DRAM 165-170 into one or more of the plurality of levels of cache 120-150, and write data from one or more of the plurality of levels of cache 120-150. The one or more interconnect interfaces 155-160 can further include interconnect interfaces 160 to interconnect the processor 100 to one or more input/output devices 175, other processors and the like. For example, the one or more interconnect interfaces 160 can include, but is not limited to, a bi-direction serial and/parallel communication interface, such as but not limited to a hyper transport (HT) interface coupled between one or more input output device 175, the one or more memory controllers 155 and the one or more shared level three (L3) cache 150.

A given cache layer can be inclusive, exclusive, or a non-inclusive non-exclusive (NINE) of a next higher cache layer. As used herein, the terms lower and higher cache levels will be used to refer to cache layers relative to each other. In an inclusive cache policy, blocks of data and/or instructions in a higher-level cache are also present in a lower-level cache. In other words, the lower-level cache is inclusive of the higher-level cache. In an exclusive cache policy, blocks of data and or instructions in a lower-level cache are not present in the higher-level cache. In other words, the lower-level cache is exclusive of the higher-level cache. If the contents of the lower-level cache are neither strictly inclusive nor exclusive of the higher-level cache, the lower-level cache is considered to be non-inclusive non-exclusive. Referring now to FIG. 2, an inclusive cache method according to the conventional art is shown. The inclusive cache method will be described with reference to the level two (L2) cache and the shared level three (L3) cache of FIG. 1. The method can include receiving a current memory access request from a given one of the plurality of cores, at 205. At 210, it can be determined if data and/or instructions for a given physical page number (PPN) of the memory access request is cached in a given higher level cache. For example, it can be determined if data and/or instructions is cached in a given level two (L2) cache 140. If the data and/or instructions for the given physical page number is found in the given higher-level cache (e.g., cache hit), the data and/or instructions can be fetched from the given higher-level cache and placed in a given further higher-level cache in accordance with a corresponding cache policy or returned to the given one of the plurality of cores, at 215. For example, data and/or instructions can be fetched from the given level two (L2) cache 140 and placed in a given level one (L1) cache 125 and/or returned to the given core 110. If the data and/or instructions for the given physical page number is not found in the given higher-level cache (e.g., cache miss), it can be determined if the data and/or instructions for the given physical page number of the memory access request is cached in a given lower-level cache, at 220. For example, if there is a cache miss at the given level two (L2) cache 140, it can be determined if the data and/or instructions for the given physical page number of the memory access request received from a given core 110 is cached in a shared level three (L3) cache 150. If the data and/or instructions for the given physical page number is found in the given lower-level cache, the data and/or instructions can be fetched from the given lower-level cache and placed in the given higher-level cache, at 225. For example, data and/or instructions can be fetched from the shared level three (L3) cache 150 and placed in a given level two (L2) cache 140. If the data and/or instructions for the given physical page number is not found in the given lower-level cache, the data and/or instructions for the given physical page number of the memory access request can be fetched from a further lower-level cache or from memory and placed in both the given lower-level cache and the given higher-level cache, at 230. For example, if the data and/or instructions is not found in the shared level three (L3) cache 150, the data and/or instructions can be fetched from either a next lower-level cache if applicable or from memory 165-170. The fetched data and/or instructions can be placed in both the shared level three (L3) cache 150 and the given level two (L2) cache 140. At 235, if there is an eviction of other data and/or instructions from the given lower-level cache, the other data and/or instructions can also be invalidated/evicted from the given higher-level cache. For example, if other data and/or instructions are evicted from the shared level three (L3) cache 150 to make room for the fetched data and/or instructions for the given physical page number of the memory access request, the corresponding other data and/or instructions also cached in the given level two (L2) cache 140 can be invalidated or evicted. The inclusive cache method advantageously filters unnecessary coherence snoop traffic. However, the inclusive cache method wastes effective cache capacity.

Referring now to FIG. 3, an exclusive cache method according to the conventional art is shown. The exclusive cache method will be described with reference to the level two (L2) cache and the shared level three (L3) cache of FIG. 1. The method can include receiving a current memory access request from a given one of the plurality of cores, at 305. At 310, it can be determined if data and/or instructions for a given physical page number of the memory access request is cached in a given higher-level cache. For example, it can be determined if data and/or instructions is cached in a given level two (L2) cache 140. If the data and/or instructions for the given physical page number is found in the given higher-level cache (e.g., cache hit), the data and/or instructions can be fetched from the given higher-level cache and placed in a given further higher-level cache in accordance with a corresponding cache policy or returned to the given one of the plurality of cores, at 315. For example, data and/or instructions can be fetched from the given level two (L2) cache 140 and placed in a given level one (L1) cache 125 and/or returned to the given core 110. If the data and/or instructions for the given physical page number is not found in the given higher-level cache (e.g., cache miss), it can be determined if the data and/or instructions for the given physical page number of the memory access request is cached in a given lower-level cache, at 320. For example, if there is a cache miss at the given level two (L2) cache 140, it can be determined if the if data and/or instructions for the given physical page number of the memory access request received from a given core 110 is cached in a shared level three (L3) cache 150. If the data and/or instructions for the given physical page number is found in the given lower-level cache, the data and/or instructions can be moved from the given lower-level cache into the given higher-level cache, at 325. For example, data and/or instructions can be move out from the shared level three (L3) cache 150 and placed into a given level two (L2) cache 140. At 330, if there is an eviction of other data and/or instructions from the given higher-level cache, the other data and/or instructions can be placed the given lower-level cache. For example, if other data and/or instructions are evicted from the given level two (L2) cache 140 to make room for the moved data and/or instructions for the given physical page number of the memory access request, the corresponding other data and/or instructions can be moved to the shared level three (L3) cache 150. If the data and/or instructions for the given physical page number is not found in the given lower-level cache, the data and/or instructions for the given physical page number of the memory access request can be fetched from a further lower-level cache or from memory and placed in the given higher-level cache, at 335. For example, if the data and/or instructions is not found in the shared level three (L3) cache 150, the data and/or instructions can be fetched from either a next lower-level cache if applicable or from memory 165-170. The fetched data and/or instructions can be placed in the given level two (L2) cache 140. Again, if there is an eviction of other data and/or instructions from the given higher-level cache, the other data and/or instructions can be placed the given lower-level cache, at 340. For example, if other data and/or instructions are evicted from the given level two (L2) cache 140 to make room for the fetched data and/or instructions for the given physical page number of the memory access request, the corresponding other data and/or instructions can be moved to the shared level three (L3) cache 150. The exclusive cache method advantageously provides a large effective cache capacity. However, the exclusive cache method is characterized by higher complexity in order to maintain exclusiveness and cache coherency.

Referring now to FIG. 4, a non-inclusive non-exclusive cache method according to the conventional art is shown. The non-inclusive non-exclusive cache method will be described with reference to the level two (L2) cache and the shared level three (L3) cache of FIG. 1. The method can include receiving a current memory access request from a given one of the plurality of cores, at 405. At 410, it can be determined if data and/or instructions for a given physical page number of the memory access request is cached in a given higher-level cache. For example, it can be determined if data and/or instructions is cached in a given level two (L2) cache 140. If the data and/or instructions for the given physical page number is found in the given higher-level cache (e.g., cache hit), the data and/or instructions can be fetched from the given higher-level cache and placed in a given further higher-level cache in accordance with a corresponding cache policy or returned to the given one of the plurality of cores, at 415. For example, data and/or instructions can be fetched from the given level two (L2) cache 140 and placed in a given level one (L1) cache 125 and/or returned to the given core 110. If the data and/or instructions for the given physical page number is not found in the given higher-level cache (e.g., cache miss), it can be determined if the data and/or instructions for the given physical page number of the memory access request is cached in a given lower-level cache, at 420. For example, if there is a cache miss at the given level two (L2) cache 140, it can be determined if the data and/or instructions is cached in a shared level three (L3) cache 150. If the data and/or instructions for the given physical page number is found in the given lower-level cache, the data and/or instructions can be fetched from the given lower-level cache and placed in the given higher-level cache, at 425. For example, data and/or instructions can be fetched from the shared level three (L3) cache 150 and placed in a given level two (L2) cache 140. If the data and/or instructions for the given physical page number is not found in the given lower-level cache, the data and/or instructions for the given physical page number of the memory access request can be fetched from a further lower-level cache or from memory and placed in both the given lower-level cache and the given higher-level cache, at 430. For example, if the data and/or instructions is not found in the shared level three (L3) cache 150, the data and/or instructions can be fetched from either a next lower-level cache if applicable or from memory 165-170. The fetched data and/or instructions can be placed in both the shared level three (L3) cache 150 and the given level two (L2) cache 140. In the non-inclusive non-exclusive cache method there is no back invalidation and/or eviction. The non-inclusive non-exclusive cache method is closer to the inclusive cache policy than the exclusive cache policy, as it keeps fetched data and/or instructions in the lower-level cache. The non-inclusive non-exclusive cache method can be relatively simple to implement, but provides limited improvement in the effective cache capacity. The non-inclusive non-exclusive cache method is also characterized by complex cache coherency.

Although the inclusive, exclusive and non-inclusive non-exclusive cache methods provide various tradeoffs, there is a continuing need for improved cache systems and methods.

### SUMMARY OF THE INVENTION

The present technology may best be understood by referring to the following description and accompanying drawings that are used to illustrate embodiments of the present technology directed toward core aware non-inclusive non-exclusive (NINE) cache techniques.

In one embodiment, a non-inclusive non-exclusive cache method can include receiving memory access requests from one or more of a plurality of cores. Data and/or instructions can be cached with respect to a shared lower-level cache and a core specific higher-level cache based on physical page number (PPN) and core identifier sets for previous accesses to the respective physical page numbers.

In another embodiment, a non-inclusive non-exclusive cache method can include receiving memory access requests from one or more of a plurality of cores. Data and/or instructions can be cached with respect to a shared lower-level cache and a core specific higher-level cache based physical page number and core valid bit vector sets for previous accesses to the respective physical page numbers by each of the plurality of cores.

In another embodiment, a compute system can include a multicore processor, one or more cache levels specific to respective ones of the plurality of compute cores, and one or more cache levels shared by the plurality of compute cores, and a core sharing agent. The core sharing agent can be configured to non-inclusive non-exclusive cache data and/or instructions in a shared cache layer relative to a core specific cache layer based on the core sharing behavior of the shared cache layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows an exemplary processor according to the conventional art.

FIG. 2 shows an inclusive cache method according to the conventional art.

FIG. 3 shows an exclusive cache method according to the conventional art.

FIG. 4 shows a non-inclusive non-exclusive (NINE) cache method according to the conventional art.

FIG. 5 shows an exemplary processor, in accordance with aspects of the present technology.

FIGS. 6A-6B show a core-aware non-inclusive non-exclusive cache method, in accordance with aspects of the present technology.

FIG. 7 shows a core-aware caching data array, in accordance with aspects of the present technology.

FIGS. 8A-8B, a core-aware non-inclusive non-exclusive cache method, in accordance with aspects of the present technology.

FIG. 9 shows a core-aware caching data array, in accordance with aspects of the present technology.

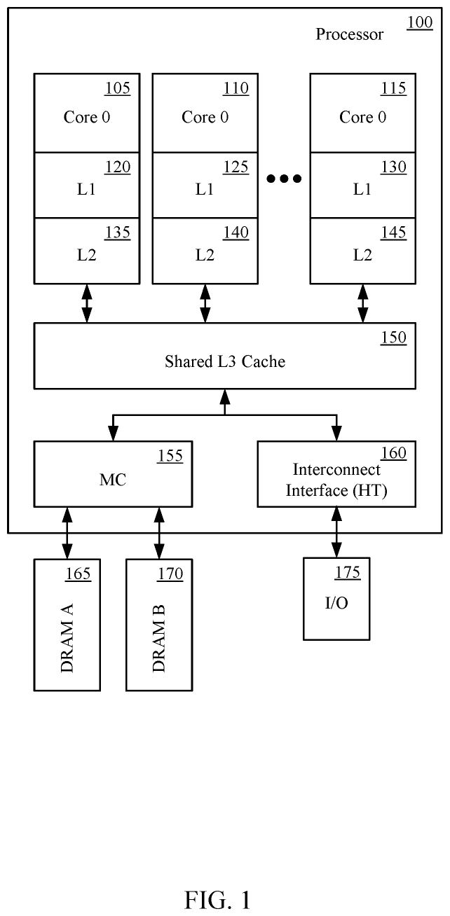

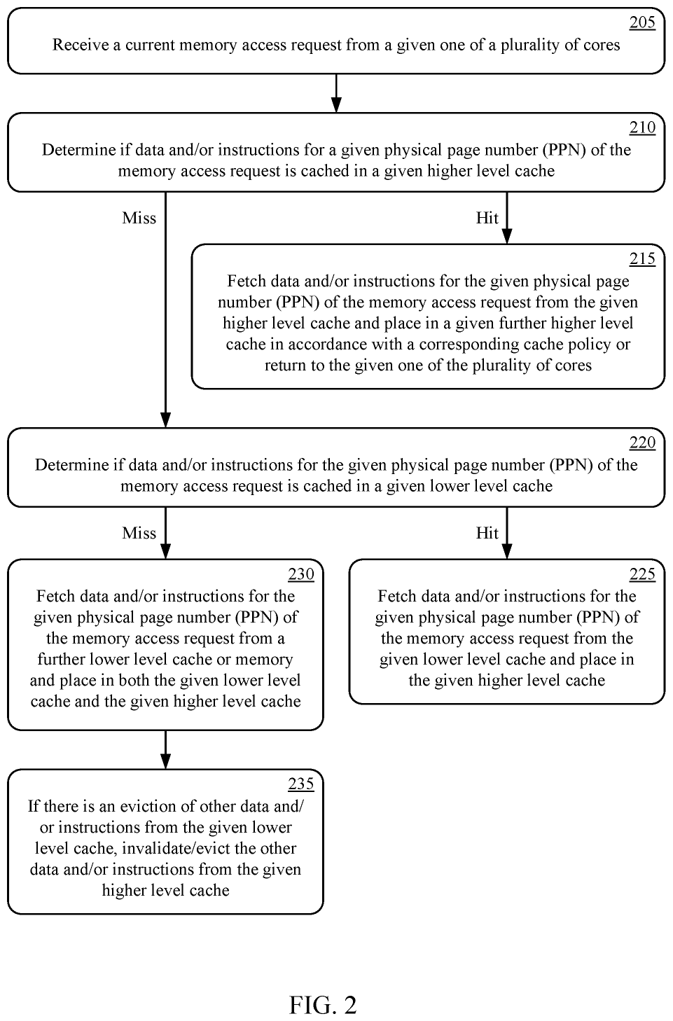

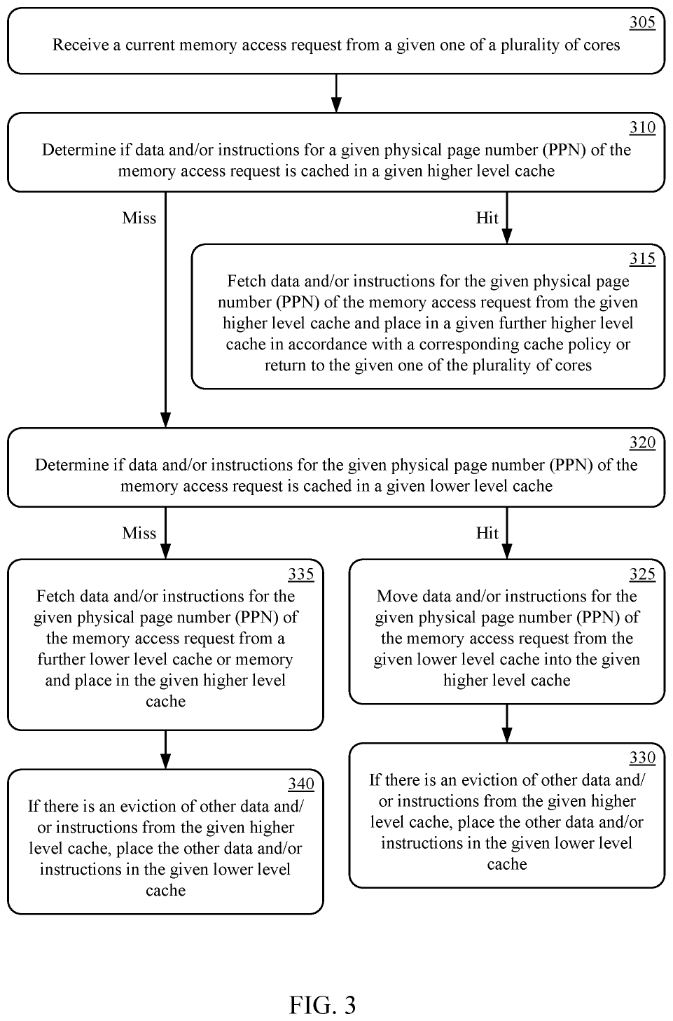

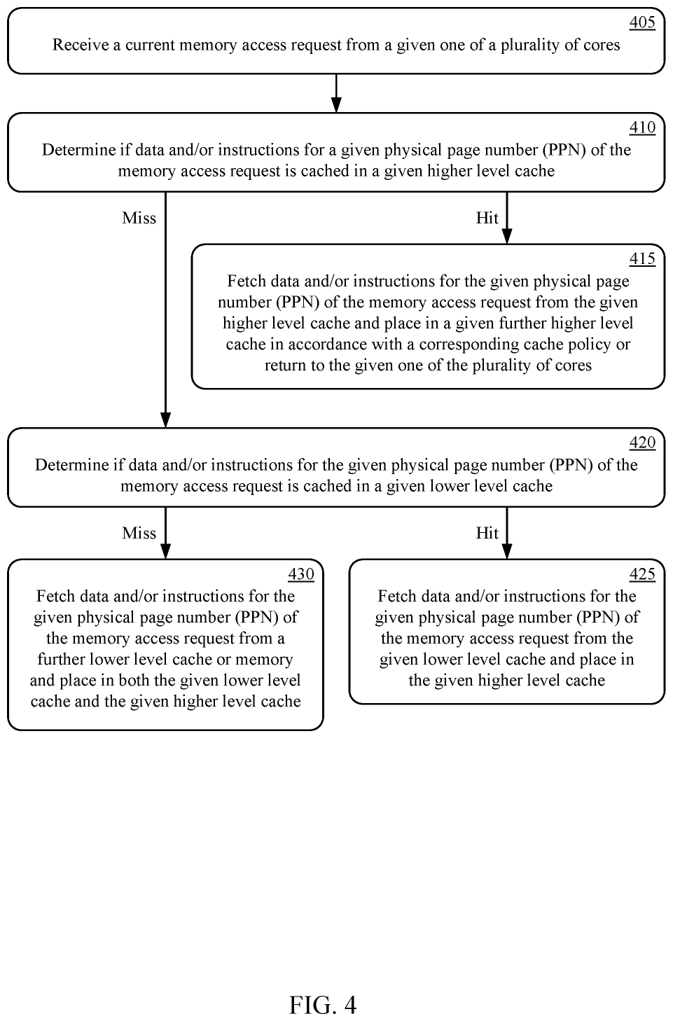

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

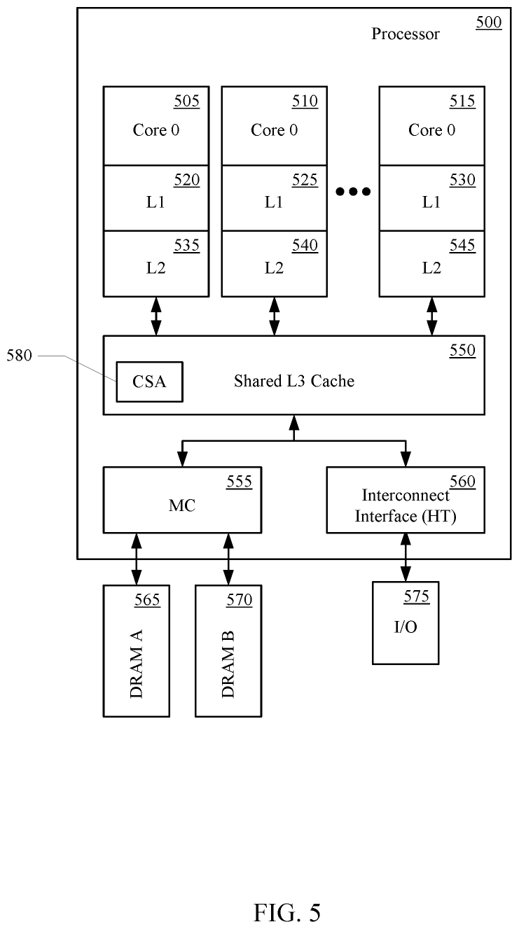

Referring now to FIG. 5, an exemplary processor, in accordance with aspects of the present technology, is shown. The processor 500 can include, but is not limited to, a plurality of cores 505-515, a plurality of levels of cache 520-550, and one or more interconnect interfaces 555-560. The plurality of levels of cache 520-550 can include one or more levels of cache 520-545 that are specific to respective ones of the plurality of cores 505-515, and one or more levels of cache 550 that are shared between the plurality of cores 505-515. For example, the processor 500 can include a plurality of level one (LI) caches 520-530 and a plurality of level two (L2) caches 535-545. Each level one (LI) cache 520-530 and each level two (L2) cache 535-545 can be configured to cache data and/or instructions for a respective one of the plurality of cores 505-515. The plurality of levels of cache 520-550 can also include one or more levels of cache 550 that are shared by the plurality of cores 505-515. For example, the processor 500 can include one or more level three (L3) caches 550 that are configured to cache data and/or instructions for the plurality of cores 505-515.

The one or more interconnects can include one or more memory controllers 555 configured to processes memory accesses requests. The one or more memory controllers 555 can be coupled between one or more external memories 565-570 and one or more of the levels of cache 520-550. For example, the processor 500 can include a memory controller 555 coupled between one or more dynamic random-access memory (DRAM) 565-570 and the plurality of levels of cache 520-550. The memory controller 555 can be configured to read data from the DRAM 565-570 into one or more of the plurality of levels of cache 520-550, and write data from one or more of the plurality of levels of cache 520-550 into the DRAM 565-570.

The one or more interconnect interfaces 555-560 can further include interconnect interfaces 560 to interconnect the processor 500 to one or more input/output devices 575, other processors and the like. For example, the one or more interconnect interfaces 560 can include, but is not limited to, a bi-direction serial and/parallel communication interface, such as but not limited to a hyper transport (HT) interface coupled between one or more input output device 575, the one or more memory controllers 555 and the one or more shared level three (L3) cache 550.

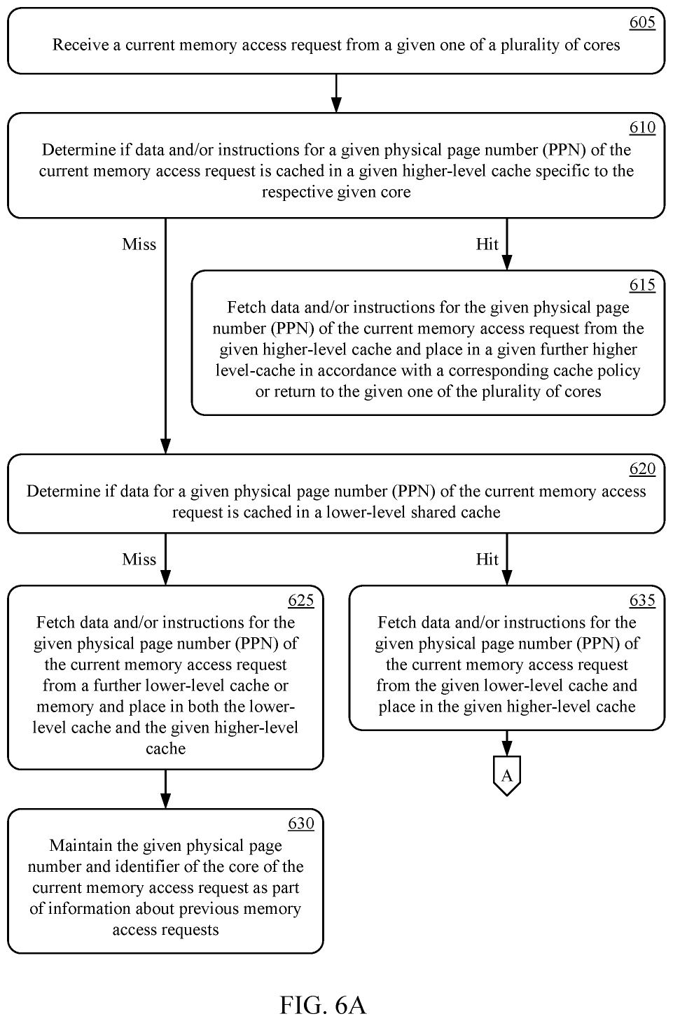

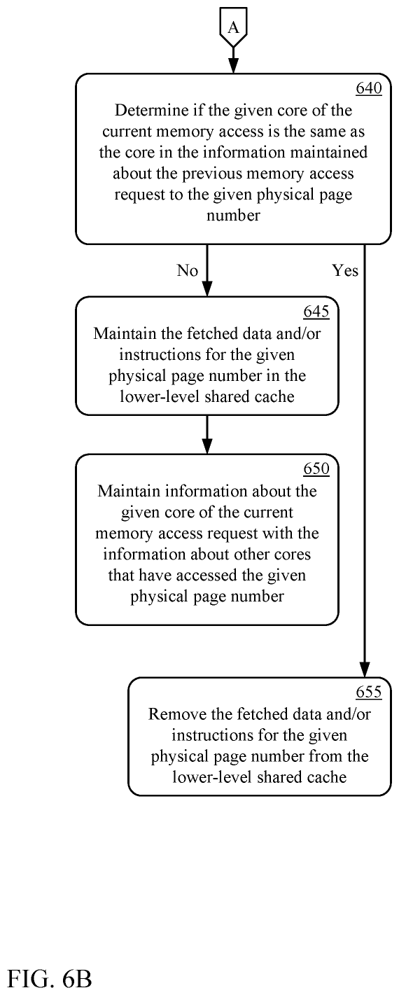

The processor 500 can further include a core sharing agent (CSA) 580. In one implementation, the core sharing agent 580 can be integral to a given cache level or can be a discrete subsystem of the processor 500. The core sharing agent 580 can be configured to implement a core aware non-inclusive non-exclusive (NINE) cache policy. The core aware non-inclusive non-exclusive cache policy and operation of the core sharing agent 580 will be further explained with reference to FIGS. 6A-6B, 7, 8A-8B and 9.

Referring now to FIGS. 6A-6B, a core-aware non-inclusive non-exclusive (NINE) cache method, in accordance with aspects of the present technology, is shown. The method can include receiving a current memory access request from a given one of the plurality of cores, at 605. At 610, it can be determined if data and/or instructions for a given physical page number (PPN) of the current memory access request is cached in a given higher-level cache specific (private, allocated, exclusive, etc.) to the respective given core. For example, it can be determined if data and/or instructions is cached in a given level two (L2) cache 540 for the given core 510. If the data and/or instructions for the given physical page number is found in the given higher-level cache (e.g., cache hit), the data and/or instructions can be fetched from the given higher-level cache and placed in a given further higher-level cache in accordance with a corresponding cache policy or returned to the given one of the plurality of cores, at 615. For example, data and/or instructions can be fetched from the given level two (L2) cache 540 and placed in a given level one (L1) cache 525 and/or returned to the given core 510.

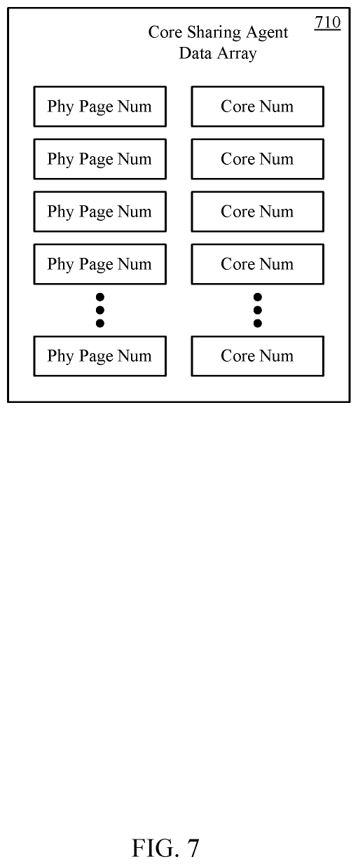

If the data and/or instructions for the given physical page number is not found in the given higher-level cache (e.g., cache miss), it can be determined if the data and/or instructions for the given physical page number of the memory access request is cached in a given lower-level shared cache, at 620. For example, if there is a cache miss at the given level two (L2) cache 540, it can be determined if the data and/or instructions is cached in a shared level three (L3) cache 550. If the data and/or instructions for the given physical page number is not found in the given lower-level cache, the data and/or instructions for the given physical page number of the memory access request can be fetched from a further lower-level cache or from memory and placed in both the given lower-level cache and the given higher-level cache, at 625. For example, if the data and/or instructions is not found in the shared level three (L3) cache 550, the data and/or instructions can be fetched from either a next lower-level cache if applicable or from memory 165-170. The fetched data and/or instructions can be placed in both the shared level three (L3) cache 550 and the given level two (L2) cache 540. At 630, the given physical page number and identifier of the core of the current memory access request can be maintained as part of information about previous memory access requests. For example, the core sharing agent 580 can be configured to add the given physical page number and core number for the current memory access request to a data array 710 including the physical page number and core number of other memory access requests, as illustrated in FIG. 7. In one implementation, the data array 710 can include one or more sets of physical page numbers and corresponding identifier, such as a core number, of the compute core that last accessed the physical page number, for previous memory access requests. The core sharing agent 580 can therefore act as a fully/set associative cache, wherein the physical page numbers in the table are used as the tag bits and index bits if set associative and the core number is stored in the data array of the cache.

If the data and/or instructions for the given physical page number is found in the given lower-level cache, the data and/or instructions can be fetched from the given lower-level cache and placed in the given higher-level cache, at 635. For example, data and/or instructions can be fetched from the shared level three (L3) cache 550 and placed in a given level two (L2) cache 540. In addition, it can be determined if the given core of the current memory access request is the same as one of the cores in the information maintained about the previous memory access requests to the given physical page number, at 640. For example, the core sharing agent 580 can be configured to determine if the physical page number of the current memory access request matches a physical page number in the data array. If there is a matching physical page number in the data array 710, it can be determined if the core number for the current memory access request matches the core number associated with the matching physical page number in the data array 710. If the given core of the current memory access is not the same as any one the cores in the information maintained about the previous memory access request to the given physical page number, the fetched cache line for the given physical page number can be maintained in the lower-level shared cache, at 645. In addition, information about the given core of the current memory access request can be maintained with information about other cores that have accessed the given physical page number, if the given core of the current memory access is not the same as the core in the information maintained about the previous memory access request to the given physical page number, at 650. If the given core of the current memory access is the same as one of the cores in the information maintained about the previous memory access request to the given physical page number, the fetched data and/or instructions for the given physical page number can be removed from the lower-level shared cache, at 655.

The core number identifier, in core sharing-aware non-inclusive non-exclusive cache method can identify 128 cores in one byte. Therefore, the core sharing-aware non-inclusive non-exclusive cache method utilizing core number identifier can provide a relatively coarse-grained cache control as compared to the following cache method based on core valid bit vectors.

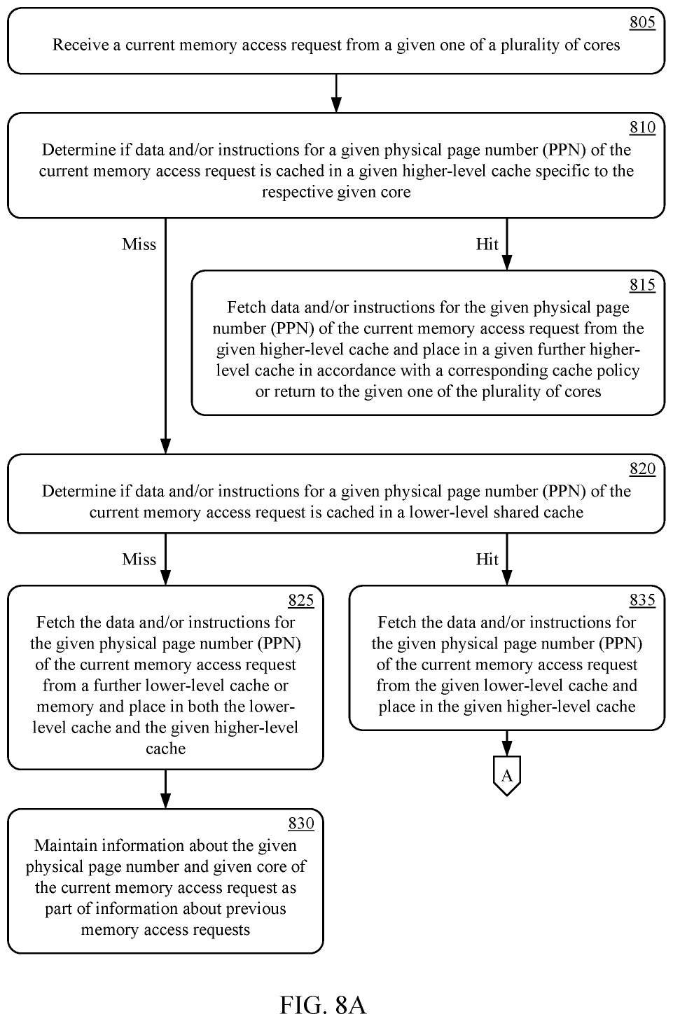

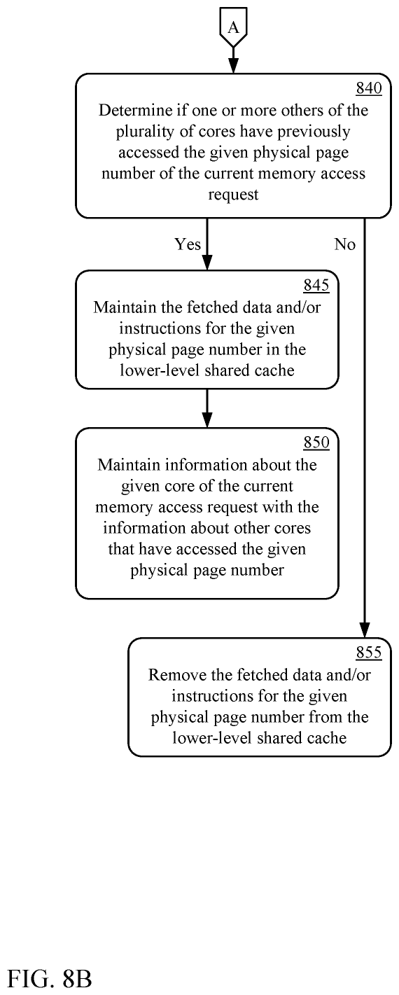

Referring now to FIGS. 8A-8B, a core sharing-aware non-inclusive non-exclusive cache method, in accordance with aspects of the present technology, is shown. The method can include receiving a current memory access request from a given one of the plurality of cores, at 805. At 810, it can be determined if data and/or instructions for a given physical page number of the memory access request is cached in a given higher-level cache specific (private, allocated, exclusive, etc.) to the respective given core. For example, it can be determined if data and/or instructions is cached in a given level two (L2) cache 540. If the data and/or instructions for the given physical page number is found in the given higher-level cache (e.g., cache hit), the data and/or instructions can be fetched from the given higher-level cache and placed in a given further higher-level cache in accordance with a corresponding cache policy or returned to the given one of the plurality of cores, at 815. For example, data and/or instructions can be fetched from the given level two (L2) cache 540 and placed in a given level one (L1) cache 525 and/or returned to the given core 510.

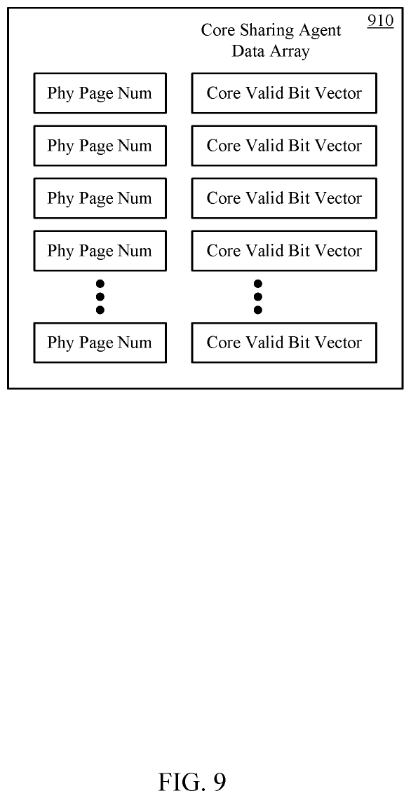

If the data and/or instructions for the given physical page number is not found in the given higher-level cache (e.g., cache miss), it can be determined if the data and/or instructions for the given physical page number of the memory access request is cached in a given lower-level shared cache, at 820. For example, if there is a cache miss at the given level two (L2) cache 540, it can be determined if the data and/or instructions is cached in a shared level three (L3) cache 550. If the data and/or instructions for the given physical page number is not found in the given lower-level cache, the data and/or instructions for the given physical page number of the memory access request can be fetched from a further lower-level cache or from memory and placed in both the given lower-level cache and the given higher-level cache, at 825. For example, if the data and/or instructions is not found in the shared level three (L3) cache 550, the data and/or instructions can be fetched from either a next lower-level cache if applicable or from memory 565-570. The fetched data and/or instructions can be placed in both the shared level three (L3) cache 550 and the given level two (L2) cache 540. At 830, the given physical page number for the current memory access request from the given core can be maintained as part of information about previous memory access requests. For example, the core sharing agent 580 can be configured to add the given physical page number and bit of a core valid bit vector corresponding to the corresponding core for the current memory access request in a data array 910, as illustrated in FIG. 9. In one implementation, the data array 910 can include one or more sets of physical page numbers and corresponding core valid bit vectors, wherein the core valid bit vector includes a bit for each of the plurality of compute cores of the processor.

If the data and/or instructions for the given physical page number is found in the given lower-level cache, the data and/or instructions can be fetched from the given lower-level cache and placed in the given higher-level cache, at 835. For example, data and/or instructions can be fetched from the shared level three (L3) cache 550 and placed in a given level two (L2) cache 540. In addition, it can be determined if one or more others of the plurality of cores have previously accessed the given physical page number of the memory access request, at 840. For example, the core sharing agent 580 can be configured to determine if, for the given physical page number of the current memory access request, one or more bits of the corresponding core valid bit vector in the data array 910 are in a given state that indicates one or more other cores have previously access the given physical page number. If one or more bit in the corresponding core valid bit vector in the data array 910 indicate that one or more other cores have accessed the given physical page number, the fetched cache line for the given physical page number can be maintained in the lower-level shared cache, at 845. In addition, information about the given core of the memory access request can be maintained with information about other cores that have accessed the given physical page number, if one or more other cores have previously accessed the given physical page number, at 850. If one or more other cores have not accessed the given physical page number, the fetched data and/or instructions for the given physical page number can be removed from the lower-level shared cache, at 855. In one implementation, the core valid bit vectors in the core sharing agent data array 910 can be reset so that data in instructions for corresponding physical page number are not continuously maintained in the lower-level shared cache.

The core sharing-aware non-inclusive non-exclusive cache method utilizing core valid bit vectors can advantageously enable fine-gained cache control. The core valid bit vector can advantageously record core access history for a period of time. Accordingly, a fetched cache line can be maintained in a lower-level shared cache based on the corresponding valid core bits when a number of cores have accessed the corresponding physical page number. The core sharing-aware non-inclusive non-exclusive cache method utilizing core valid bit vectors however can have higher storage overhead as compared to a core number identifier, as one byte of core valid bit vector can only represent eight compute cores.

Aspects of the present technology advantageously provide a non-inclusive non-exclusive cache policy based on core sharing behaviors. The non-inclusive non-exclusive cache policies in accordance with aspects of the present technology advantageously achieve a relatively large effective capacity similar to an exclusive cache policy. The non-inclusive non-exclusive cache policies in accordance with aspects of the present technology advantageously reduce cache misses in the cases of inter-core data sharing.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A non-inclusive non-exclusive (NINE) cache method comprising:
receiving memory access requests from one or more of a plurality of cores; and
core aware non-inclusive non-exclusive caching of data and/or instructions between a shared cache level and a core specific cache level based on physical page number (PPN) and core identifiers sets for previous accesses to the respective physical page numbers.

2. The non-inclusive non-exclusive cache method of claim 1, further comprising:
determining if data and/or instructions for a given physical page number of the current memory access request received from a given one of a plurality of cores of a processor is cached in a lower-level shared cache;
fetching data and/or instructions for the given physical page number of the current memory access request from a further lower-level cache or memory and place in both the lower-level cache and the given higher-level cache, when the data and/or instructions for a given physical page number of a current memory access request is not cached in a lower-level shared cache;
maintaining the given physical page number and identifier of the core of the current memory access request as part of information about previous memory access requests, when the data and/or instructions for a given physical page number of a current memory access request is not cached in a lower-level shared cache;
fetching data and/or instructions for the given physical page number of the current memory access request from the given lower-level cache and place in the given higher-level cache, when the data and/or instructions for a given physical page number of a current memory access request is cached in a lower-level shared cache;
determining if the given core of the current memory access is the same as the core in the information maintained about the previous memory access request to the given physical page number, when the data and/or instructions for a given physical page number of a current memory access request is cached in a lower-level shared cache;
maintaining the fetched data and/or instructions for the given physical page number in the lower-level shared cache, when the given core of the current memory access is not the same as the core in the information maintained about the previous memory access request to the given physical page number;
maintaining information about the given core of the current memory access request with the information about other cores that have accessed the given physical page number, when the given core of the current memory access is not the same as the core in the information maintained about the previous memory access request to the given physical page number; and
removing the fetched data and/or instructions for the given physical page number from the lower-level shared cache, when the given core of the current memory access is the same as the core in the information maintained about the previous memory access request to the given physical page number.

3. The non-inclusive non-exclusive cache method of claim 2, wherein maintaining information about the given physical page number and given core of the current memory access request as part of information about previous memory access requests, when the data and/or instructions for a given physical page number of a current memory access request is not cached in a lower-level shared cache, comprises:
adding the given physical page number and corresponding core valid bit vector to a data array, wherein a bit of the core valid bit vector corresponding to the given core is set to a given state.

4. The non-inclusive non-exclusive cache method of claim 3, wherein maintaining information about the given core of the current memory access request with the information about other cores that have accessed the given physical page number, when one or more others of the plurality of cores have previously accessed the given physical page number of the current memory access request comprises:
setting a bit of the core valid bit vector corresponding to the given core to a given state in the core valid bit vector corresponding to the physical page number of the current memory access request.

5. The non-inclusive non-exclusive cache method of claim 2, further comprising:
determining if the data and/or instructions for the given physical page number of the current memory access request is cached in the given higher-level cache specific to the respective given core; and
fetching the data and/or instructions for the given physical page number of the current memory access request from the given higher-level cache and place in a given further higher-level cache in accordance with a corresponding cache policy or return to the given one of the plurality of cores.

6. The non-inclusive non-exclusive cache method of claim 1, wherein the lower-level shared cache comprises a lowest-level cache of the processor.

7. The non-inclusive non-exclusive cache method of claim 6, wherein the given high-level cache is specific to the given one of the plurality of compute cores.

8. A non-inclusive non-exclusive cache method comprising:
receiving memory access requests from one or more of a plurality of cores; and
core aware non-inclusive non-exclusive caching of data and/or instructions between a shared cache level and a core specific cache level based on physical page number and core valid bit vector sets for previous accesses to the respective physical page numbers by each of the plurality of cores.

9. The non-inclusive non-exclusive (NINE) cache method of claim 8, further comprising:
determining if data and/or instructions for a given physical page number (PPN) of the current memory access request received from a given one of a plurality of cores of a processor is cached in a lower-level shared cache;
fetching the data and/or instructions for the given physical page number of the current memory access request from a further lower-level cache or memory and placing in both the lower-level cache and a given higher-level cache, when the data and/or instructions for a given physical page number of a current memory access request is not cached in a lower-level shared cache;
maintaining information about the given physical page number and given core of the current memory access request as part of information about previous memory access requests, when the data and/or instructions for a given physical page number of a current memory access request is not cached in a lower-level shared cache;
fetching the data and/or instructions for the given physical page number of the current memory access request from the given lower-level cache and placing in the given higher-level cache, when the data and/or instructions for a given physical page number of a current memory access request is cached in a lower-level shared cache;
determining if one or more others of the plurality of cores have previously accessed the given physical page number of the current memory access request, when the data and/or instructions for a given physical page number of a current memory access request is cached in a lower-level shared cache;
maintaining the fetched data and/or instructions for the given physical page number in the lower-level shared cache, when one or more others of the plurality of cores have previously accessed the given physical page number of the current memory access request;
maintaining information about the given core of the current memory access request with the information about other cores that have accessed the given physical page number, when one or more others of the plurality of cores have previously accessed the given physical page number of the current memory access request; and
removing the fetched data and/or instructions for the given physical page number from the lower-level shared cache, when one or more others of the plurality of cores have not previously accessed the given physical page number of the current memory access request.

10. The non-inclusive non-exclusive cache method of claim 9, wherein maintaining information about the given physical page number and given core of the current memory access request as part of information about previous memory access requests, when the data and/or instructions for a given physical page number of a current memory access request is not cached in a lower-level shared cache, comprises:
adding the given physical page number and corresponding core valid bit vector to a data array, wherein a bit of the core valid bit vector corresponding to the given core is set to a given state.

11. The non-inclusive non-exclusive cache method of claim 10, wherein maintaining information about the given core of the current memory access request with the information about other cores that have accessed the given physical page number, when one or more others of the plurality of cores have previously accessed the given physical page number of the current memory access request comprises:
setting a bit of the core valid bit vector corresponding to the given core to a given state in the core valid bit vector corresponding to the physical page number of the current memory access request.

12. The non-inclusive non-exclusive cache method of claim 9, further comprising:
determining if the data and/or instructions for the given physical page number of the current memory access request is cached in the given higher-level cache specific to the respective given core; and
fetching the data and/or instructions for the given physical page number of the current memory access request from the given higher-level cache and place in a given further higher-level cache in accordance with a corresponding cache policy or return to the given one of the plurality of cores.

13. The non-inclusive non-exclusive cache method of claim 8, wherein the lower-level shared cache comprises a lowest-level cache of the processor.

14. The non-inclusive non-exclusive cache method of claim 13, wherein the given high-level cache is specific to the given one of the plurality of compute cores.

15. A processor comprising:
a plurality of compute cores;
one or more cache levels specific to respective ones of the plurality of compute cores;
one or more cache levels shared by the plurality of compute cores; and
a core sharing agent configured to non-inclusive non-exclusive (NINE) cache data and/or instructions in a shared cache layer relative to a core specific cache layer based on core sharing behavior of the shared cache layer.

16. The processor of claim 15 wherein the core sharing agent is configured to core aware non-inclusive non-exclusive cache data and/or instructions in the shared cache layer relative to the core specific cache layer based on core number identifiers.

17. The processor of claim 16, wherein the core sharing agent is configured to:

18. The processor of claim 15, wherein the core sharing agent is configured to core aware non-inclusive non-exclusive cache data and/or instructions in the shared cache layer relative to the core specific cache layer based on core valid bit vector.

19. The processor of claim 18, wherein the core sharing agent is configured to:
determine if data and/or instructions for a given physical page number of the current memory access request received from a given one of a plurality of cores of a processor is cached in a lower-level shared cache;
fetch the data and/or instructions for the given physical page number of the current memory access request from a further lower-level cache or memory and place in both the lower-level cache and a given higher-level cache, when the data and/or instructions for a given physical page number of a current memory access request is not cached in a lower-level shared cache;
maintain information about the given physical page number and given core of the current memory access request as part of information about previous memory access requests, when the data and/or instructions for a given physical page number of a current memory access request is not cached in a lower-level shared cache;
fetch the data and/or instructions for the given physical page number of the current memory access request from the given lower-level cache and place in the given higher-level cache, when the data and/or instructions for a given physical page number of a current memory access request is cached in a lower-level shared cache;
determine if one or more others of the plurality of cores have previously accessed the given physical page number of the current memory access request, when the data and/or instructions for a given physical page number of a current memory access request is cached in a lower-level shared cache;
maintain the fetched data and/or instructions for the given physical page number in the lower-level shared cache, when one or more others of the plurality of cores have previously accessed the given physical page number of the current memory access request;
maintain information about the given core of the current memory access request with the information about other cores that have accessed the given physical page number, when one or more others of the plurality of cores have previously accessed the given physical page number of the current memory access request; and
remove the fetched data and/or instructions for the given physical page number from the lower-level shared cache, when one or more others of the plurality of cores have not previously accessed the given physical page number of the current memory access request.

20. The processor of claim 19, wherein the lower-level shared cache comprises a lowest-level cache of the processor.

21. The processor of claim 19, wherein the given high-level cache is specific to the given one of the plurality of compute cores.

22. The processor of claim 19, wherein the memory comprises one or more dynamic random-access memory (DRAM).
